(19) United States
(12) Patent Application Publication
(10) Pub. No.: US 2010/0152629 A1
(43) Pub. Date: Jun. 17, 2010

(54) INTEGRATED SYSTEM TO ASSIST IN THE REHABILITATION AND/OR EXERCISING OF A SINGLE LEG AFTER STROKE OR OTHER UNILATERAL INJURY

(76) Inventors: Douglas D. Haas, JR., Sparta, NJ (US); Constantin Trantzas, Briarcliff Manor, NJ (US)

Correspondence Address: SOFER & HAROUN LLP., 317 MADISON AVENUE, SUITE 910, NEW YORK, NY, 10017, US

(21) Appl. No.: 12/572,417

(22) Filed: Oct. 2, 2009

Related U.S. Application Data
(60) Provisional application No. 61/195,069, filed on Oct. 2, 2008.

(51) Int. Cl. A61H 3/00

(52) U.S. Cl. 601/34

(57) ABSTRACT

An arrangement for the rehabilitation of a limb includes a motion capture device a control module and a gait device coupled to the control module. An affected limb is attached to the gait device so that when the user moves an unaffected limb, the motion capture device records the movements of the unaffected limb and transmits such data to the control module which in turn sends controls to the gait device to assist the movement of the affected limb.

### RELATED APPLICATION

This application claims the benefit of priority from U.S. Provisional Patent Application No. 61/195,069, filed on Oct. 2, 2008, the entirety of which is incorporated by reference.

### BACKGROUND

1. Field of the Invention

This application relates to the rehabilitation of patients after they have suffered from any of a variety of injuries including stroke or other traumatic or neurological injury that affects the movements of their legs or hands.

2. Description of Related Art

Currently, the lifting and moving of the affected leg is done by either a physical therapist who attempts to mimic a walking pattern or a custom system that includes a treadmill and off weighting system that use a rigid structure and algorithm for movement. It is well known that a prime requirement of normal gait is symmetrical movement of both legs. When a patient is unable to move the legs symmetrically they expend more energy and have reduced stability. This reduced stability often lead to falls causing further injury.

Furthermore, it is known that rehabilitation and physical therapy are major components of treatment to restore the physical mobility and functionality of patients with injuries affecting ambulation. To date, this treatment often includes training on a treadmill with an off weighting system (such as “LiteGait™”) often with the direct assistance of a group of Physical Therapist or using a device like a “Locomat™” and “Auto Ambulator™” which attempts to rehabilitate patients with bi-lateral injuries by using predefined movement patterns. Previous studies have identified that rigid protocols are too restrictive when applied to unilateral injuries and the physical labor required to manually move the affected limb for an extended time period is exhausting on the therapist which leads to injury or reduced therapist availability to perform this task.

### OBJECTS AND SUMMARY

In the present arrangement, an apparatus and method of manufacturing and deploying the apparatus is employed, which provides a self adjusting system for symmetrical retraining of the gait movement. The method and apparatus employ a dynamic movement of the affected limb based on the abilities and movements of the unaffected limb.

It is noted that the various embodiments presented herein disclose arrangements for treating patients with leg mobility issues. However, the invention is not limited in this respect. For example, similar arrangements may be utilized for example on an affected arm or hand.

In one embodiment, the system may include at least three parts including:

tracking the movement of the un-affected limb in real time;

recording, storing and calculating the required movement to achieve the retraining on the affected limb in real time; and

lifting and moving the limb while the patient is walking on a tread mill.

In one embodiment, the system and method facilitates symmetrical leg movement without the physical labor currently used to lift and move the leg. This overcomes the problems associated with the requirement for the therapist to sit on the floor and repetitively lift and move the affected leg.

In another arrangement a variety of methods are used to collect the required information on the movement of the un-affected leg in time to compute and execute the instruction needed to move the affected leg.

In another arrangement, the therapist is assisted in educating and motivating the patient by providing a visual feedback loop.

In another arrangement, the system and method is economical while preserving the current investment in both treadmills and off weighting systems. The system and method provides a manner to move the limb as required without causing unnecessary discomfort or feeling to the patient.

In another arrangement, the system and method protects the subject in case of component failure or other unexpected events such as a patient fall, using such methods as quick release connection on the patient connecting points.

In another arrangement, a safe and flexible system and method is provided for adjusting the lifting and movement apparatus so it can accommodate patients of different heights and weights.

In another arrangement a system and method is provided to identify, through a feedback sensory system attached to a patient interface apparatus of the affected limb, the progress during treatment and change the level of assistance in moving the affected limb.

In another arrangement a system and method is provided to identify, through a feedback sensory system attached to the patient interface apparatus of the affected limb, the progress during treatment and change the speed of the treadmill.

In another arrangement a system and method is provided to identify, through a feedback sensory system attached to the patient interface apparatus of the affected limb, the progress during treatment and change the settings of the partial weight bearing system to allow more or less body weight bearing.

In another arrangement a system and method is provided to provide a method to also treat the foot of the affected limb, not only the thigh and leg, by assisting the foot during the gait cycle. In one arrangement, a special AFO (Ankle-Foot Orthosis) can be employed with mechanics to first correct for foot drop and second designed to allow flexibility for the foot to go through the heel-down, foot flat and toe off phases as learned from the un-affected limb. This special AFO may be attached to a special section of the robotics.

In another arrangement a system and method is provided to provide a method to identify the foot contact profile, area, geometry, timing and force/pressure, between the un-affected foot and subsurface.

In another arrangement a system and method is provided to provide a method to identify the foot contact profile, geometry, timing and force/pressure, between the affected foot and subsurface including the AFO.

In another arrangement a system and method is provided to provide a method for attaching feedback devices on the shafts/rods of the patient interface apparatus to monitor torque and extrapolate resistance/opposition to movement of the affected limb.

In another arrangement a system and method is provided to provide a method to attach and monitor EMG (Electromyography) sensors on specific muscles of the un-affected limb and learn the firing time of these specific muscles during the un-affected limb gait cycle.

In another arrangement a system and method is provided to provide a method to attach surface electrodes in the patient interface apparatus to produce electrical pulses for specific muscle stimulation on the affected limb.

In another arrangement a system and method is provided to provide a method for a therapist to stand behind the patient while in training and guide the patient's hip through the gait cycle and provide re-assurance and highly desired human touch during training.

In another arrangement a system and method is provided to provide a method to attach devices on multiple contacts, at the point of contact between the patient interface apparatus and the patient, such as to produce signals proportional to the pressure applied by the patient interface apparatus to the patient contact point.

These and other objectives are realized by providing an apparatus and method of manufacturing and deploying the apparatus for properly moving the affected leg symmetrically to the un-affected leg.

To this end an arrangement is provided for the rehabilitation of a limb having a motion capture device, a control module and a gait device coupled to the control module. An affected limb is attached to the gait device, such that when the user moves an unaffected limb, the motion capture device records the movements of the unaffected limb and transmits such data to the control module, which in turn sends controls to the gait device to assist the movement of the affected limb.

### BRIEF DESCRIPTION OF THE DRAWINGS

In the drawings, like reference characters denote similar elements throughout the several views.

FIG. 1 displays a gait rehabilitation arrangement, in accordance with one embodiment;

FIG. 2 is a close up view of a gait device from FIG. 1, in accordance with one embodiment;

FIG. 3 shows an exemplary internal view of the components of the gait movement device of FIGS. 1 and 2, in accordance with one embodiment;

FIG. 4 is an operational schematic of said gait rehabilitation arrangement from FIG. 1, in accordance with one embodiment;

FIG. 5 is a flow chart illustrating the steps involved in operating the arrangement of FIG. 1.

### DETAILED DESCRIPTION

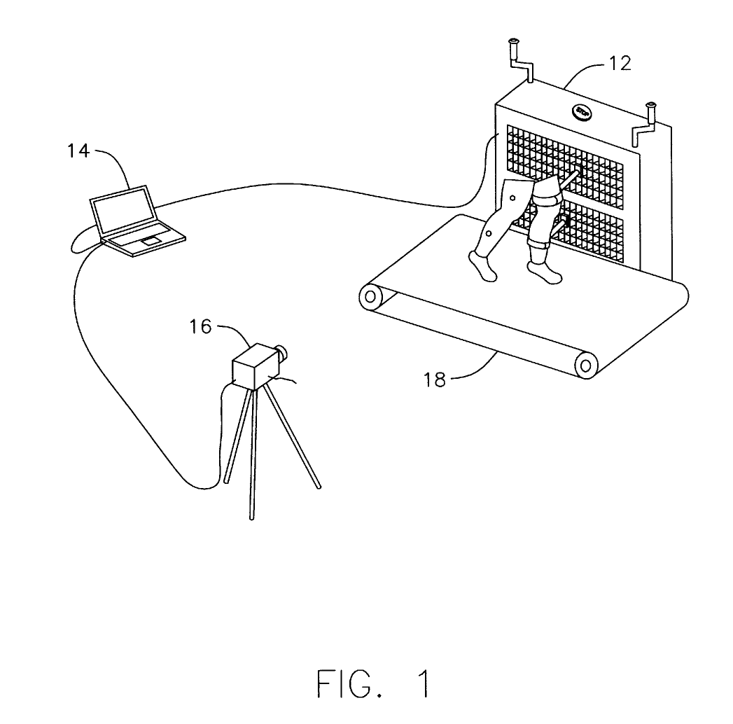

In one embodiment as shown in FIG. 1, an arrangement is shown for gait rehabilitation that utilizes the movements of an unaffected leg to assist in the gait re-training of an affected leg. As shown in FIG. 1, a treadmill 10 is used in association with a gait movement device 12. A computer controller 14 is coupled to both gait device 12 as well as a camera unit 16.

Camera unit 16 is configured to obtain image and movement data of a user's unaffected leg for collection and analysis by controller 14. In one arrangement, camera unit 16 is preferably a 2D or 3D motion capture camera, that employs light LED sensors that are placed on various portions of the user's leg that are detected by camera 16.

As an alternative, markers on the thigh, the leg, and the foot and one or more cameras 16 or CCD devices may be used. In real time such cameras 16 create a stick figure by connecting the markers worn by the users and computing acceleration, velocity, distance and three dimensional angles of movement.

In another arrangement, placement of accelerometers on the thigh, the leg, and the foot gather three dimensional acceleration data of the joints and extrapolate, in real time, acceleration, velocity, distance and three dimensional angles of movement. Accelerometers may be used either alone or as supplements to camera 16

In another arrangement, placement of inclinometers and gyroscopes on the thigh, the leg, and the foot gather three dimensional angular data of the joints and extrapolate, in real time, acceleration, velocity, distance and three dimensional angles of movement. Inclinometers may be used alone or as supplements to camera 16.

In another arrangement, placement of goniometers on hip, knee and ankle joints gather angular joint movement and extrapolate in real time acceleration, velocity, distance and three dimensional angles of movement. Goniometers may be used alone or to supplement the motion capture by camera 16.

In another arrangement, placement of pressure and or force sensors under the foot or on the sub-surface collect in real time data pertaining to the weight bearing, geometry of foot and the temporal and spatial parameters during the stance phase, foot on the ground, of the gait, etc. Such, sensors, which utilize resistive, capacitive, piezoelectric or similar technology, may be used in conjunction with camera 16.

In yet another arrangement, a physical motion capture may be used to detect the movements of the unaffected leg of the user. For example, multiple straps, each connected to the thigh, the leg, and the foot are attached via rods or other means to angular rotated devices, such as step motors. Encoders may provide a digital or analog output of the dynamic position of the thigh, the leg, and the foot. The output of these devices can be in real time transferred to the decoders or step motors or other mechanisms to create a duplicate stance phase on the affected limb. Such straps may be attached via strings to linear potentiometer devices to provide a digital or analog output of the dynamic position of the thigh, the leg, and the foot.

Any combination of the devices described above, in order to gather real time data pertinent to the dynamic position of hip, knee, ankle and toes during the leg movement may be utilized by the present arrangement.

After acquiring and processing the movement signals of the unaffected leg by any of the systems and methods outlined above, the measurements are sent to controller 14 for operating gait device 12 to move one or more leg engagement arms (described below) to provide gait retaining movements to the affected leg. In one embodiment as shown in FIG. 1 controller 14 may be any typical computer capable of managing motion capture data and running programming for operating a motorized device such as gait device 12.

In one arrangement, treadmill 18 is a typical treadmill used for rehabilitation purposes, such as those that typically function in the range of 0 to 4 mph and having elements for assisting disabled users in standing erect for the rehabilitation process. In one arrangement, treadmill 18 is outfitted with sufficient equipment to allow the user to “self-ambulate,” without the physical support of a separate physician/attendant.

It is understood that the above elements are considered exemplary. Additional elements may be added or existing elements modified to augment or supplement the features of the present arrangement.

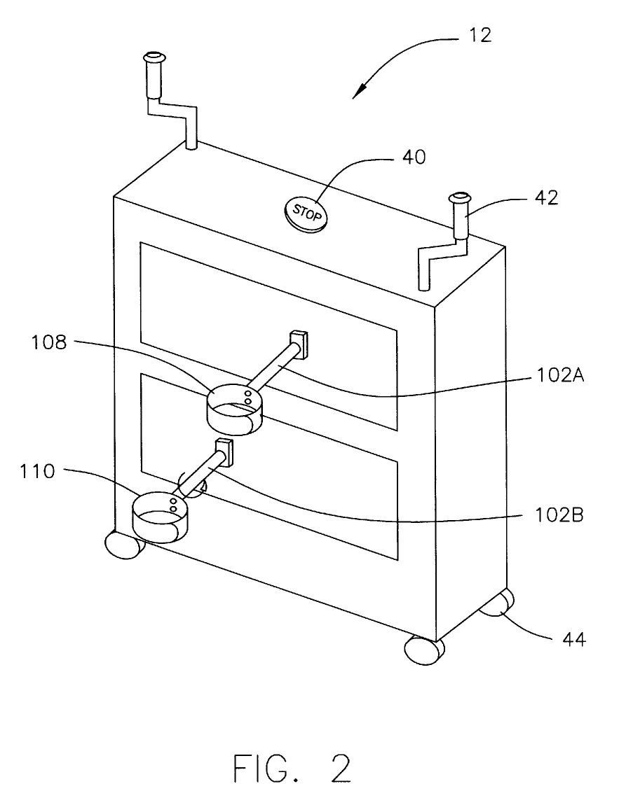

In one embodiment, as shown in FIGS. 1 and 2, gait device 12 typically includes a first upper 102a and second lower 102b leg engagement arm for coupling to an affected leg of the user. An optional third arm may be used for the motion of the user's foot. Each of arms 102a and 102b are coupled to corresponding motorized actuators 100a and 100b, respectively, for moving arms 102a and 102b to engage the user's leg in the gait re-training motions.

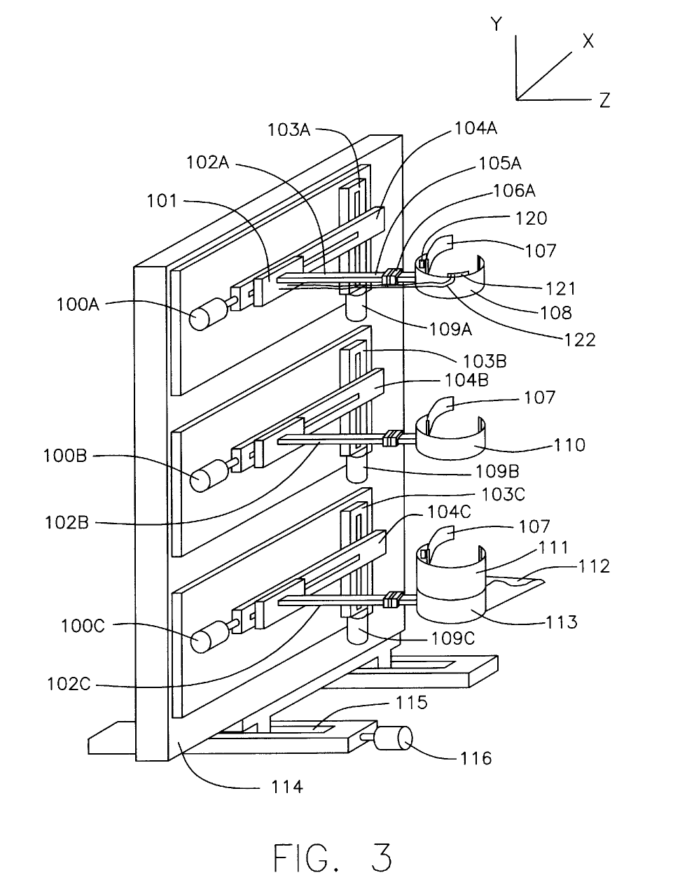

FIG. 3 shows an internal cut away of gait device 12 showing the additional component for the ankle/foot movement.

In the exemplary embodiment, shown in FIG. 3, cuff 108 is preferably made from solid plastic material molded and contoured to fit around the thigh, for attachment to the user's affected thigh and secured with strap 107. The inner contour area of cuff 108 is instrumented with a thin flexible pressure sensitive device 120 such as a force sensing resistor (FSR) or force sensing capacitive device. In this arrangement, cuff 108 is also fitted with a thin flexible air bladder 121 with electronics and pressure sensor attached at the end of the air bladder via thin flexible air tubing 122, providing a signal proportional to the pressure applied between the thigh and cuff 108 to computer 14.

In the embodiment shown in FIG. 3, cuff 110 is connected via rod 102 to plate 101. Plate 101b is attached to the X axis plate 104b and can move on the X direction via motor 100. This entire X axis assembly, motor 100, plate 101b, rod 102b is attached to plate 103b and can move on the Y axis direction by motor 109b. This entire assembly is attached to body 114 which can move on the Z direction by motor 116. Furthermore, cuff 108 attaches to rod 102a via coupling point 106a. Cuff 108a can automatically disengage from coupling point 106a when pressure conditional limits are met, via electro-magnet. Furthermore, cuff 108a can be attached to rod 102a via coupler 106a in a reverse manner to accommodate an affected opposite lower limb. Furthermore, rod 102a is instrumented with strain gauge 105a or similar technology with output to computer 14 proportional to the strain imposed on rod 102a while moving cuff 108. Furthermore, motors 100a, 109a and 116 are instrumented with torque sensors with electrical output proportional to the torque required by each motor to move cuff 108.

Cuff 110 is similar to cuff 108, except it is molded and contoured to fit around the leg and attaches to the patient's affected leg. The inner contour area of cuff 110 is instrumented in similar manner with cuff 108.

In the optional arrangement shown in FIG. 3 with third element for the user's ankle/foot, cuff 111 is similar to cuff 108 and cuff 110, expect it is molded and contoured to fit around the ankle and attaches to the user's affected leg. The inner contour area of cuff 111 is instrumented in similar manner with cuff 108. In addition, cuff 111 attaches to a bottom plate 113, the foot rest, in a way that plate 113 can move up and down. Plate 113 is further instrumented on surface area 112 in a similar manner as cuff 110. The assembly of cuff 111, plate 113 and strap 107 can be an existing AFO (ankle-foot orthotic) instrumented in a similar manner.

It is understood that the above description of the various components of gait device 12 are exemplary. Additional components may be added, and existing components may be modified.

In one embodiment, as shown for example in FIG. 2, additional components may be employed on gait device 12 for safety and ease of use. For example gait device 12 may optionally include an emergency shut off 40, and manual/motorized height adjustment means 42. If motorized they may be controlled by computer 12. Additionally, gait device 12 may employ wheels with locking levers 44 to allow a technician /physician to easily move gait device 14, for example to adjust from a right leg set up to a to left leg set up for different users.

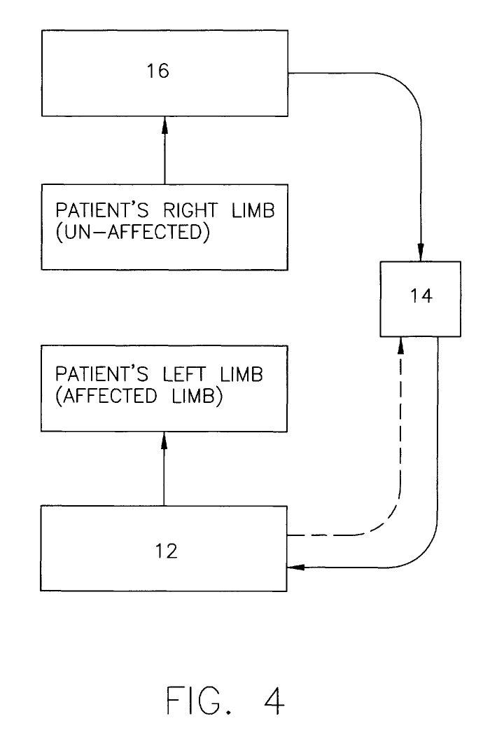

Turning to the operation of gait retraining device 12, FIG. 4 shows a high level diagram of a feedback loop for the operation of the present arrangement. A user having an affected leg (in this example the right leg) is placed on treadmill 18 with the movement of that leg being tracked by camera 16 and computer 14. The collected motion data of the unaffected leg is delivered to computer 12 and translated into control signals delivered to gait device 12 which in turn moves the affected leg (left leg) using arms 102a, 102b and 102c discussed above. Feedback from pressure sensors in the various clamps 108, 110 and 111, attached to the affected leg are fed back to computer 14 in order to track the user's progress for analysis by the physician and to potentially adjust the operation of gait device 12 as necessary.

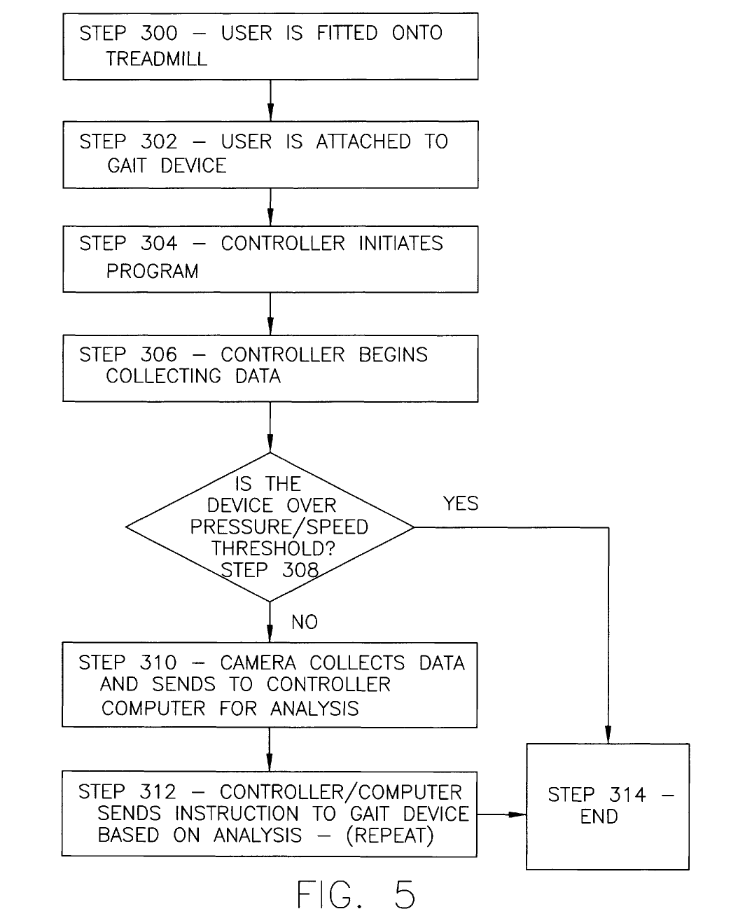

Flow chart FIG. 5 shows a more detailed view of setup and operation of the arrangement and gait device 12.

At a first step 300, the user is placed upright on treadmill 18 with the various necessary harness or assisting equipment. At step 302, the user's affected leg is then fit into the various connectors 108, 110 and 111, along with the attachment of the motion capture monitors, for example for use with camera 16.

Next at step 304, the program for operating treadmill 18 to the opening speed is done by the attendant, who may then stand beside the user for potential assistance if needed. At step 306, camera 16 begins collecting the initial motion capture data from the unaffected leg and transmitting that data to computer 14. Such data may include, but is not limited to hip, knee, and ankle angles, distance, time, foot contact profile, body weight bearing and weight bearing at foot contact.

During this process, at step 308, computer 14 continuously monitors the collected data to ensure that no safety threshold limits are exceeded. If so, an emergency shut off or slow down sequence may be automatically engaged (or engaged manually by shut off switch 40).

Assuming that the threshold is under limit, at step 310, computer 14 analyzes the collected data from the unaffected leg, sent via camera 16, and prepares motion control data to begin rehabilitation movements for the affected leg. Next, at step 312, computer 14 sends the necessary command signals to gait device 12 to begin the movement of the affected limb via elements 102a, 102b and 102c.

Once a program is initiated by computer 14, steps 306-312 are repeated for some predetermined amount of time corresponding to the intended duration of the therapy sessions. During this progression, the levels of assistance, speed body weight support, muscle stimulation and any other potential parameters are adjusted.

Finally, when the program is completed, at step 314, treadmill 18 slows and the program is completed. It is noted that completed profile and all recorded data may be recorded for later use. For example, the above described process may allow for computer 14 to store the results of a therapy session, including the controls for gait device 12. Thereafter subsequent session(s) may simply use similar control signals for gait device 12, without the need for using camera 16. This may be done when long term rehabilitation does not require that the control signals for gait device 12 be updated at each iteration. For example, instead of constant use, camera 16 may only be employed periodically when some signs of progress have been found.

As noted above, current arrangements, at least in part require the lifting and moving of the affected leg to be done by a therapist who attempt to mimic the sound leg or a custom system that includes a tread mill and off weighting system that use a rigid structure of movement rather than a dynamic movement based on the ability of the un-affected leg. However, studies have shown that such rigid protocols are too restrictive when applied to unilateral injuries and the physical labor required to manually move the affected limb for an extended time period is exhausting on the therapist which leads to injury or reduce therapist availability to perform this task. It is well known that a prime requirement of normal gait is symmetrical movement of both legs. When a patient is unable to move the legs symmetrically they expend more energy and have reduced stability. This reduced stability often lead to falls causing further injury. The present arrangement provides an automated system to reduce the manual labor required by a therapist, while simultaneously providing a feedback type system and method that improves the symmetry of movement between the affected limb and the unaffected limb by using the tracked movement of the unaffected limb to generate signals for movement of the affected limb.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An arrangement for the rehabilitation of a limb, said arrangement comprising:
a motion capture device;
a control module; and
a gait device coupled to said control module, wherein an affected limb being attached to said gait device, such that when the user moves an unaffected limb, said motion capture device records the movements of said unaffected limb and transmits such data to said control module, which in turn sends controls to said gait device to assist the movement of said affected limb.

2. The arrangement as claimed in claim 1, further comprising a treadmill, wherein said user's movements are conducted on a treadmill.

3. The arrangement as claimed in claim 2, wherein said treadmill is controlled by said control module.

4. The arrangement as claimed in claim 1, wherein said motion capture device is a motion capture camera.

5. The arrangement as claimed in claim 4, wherein said user wears motion capture indicators on said unaffected leg used for assisting said camera.

6. The arrangement as claimed in claim 1, wherein said motion capture device is selected from the group consisting of accelerometers, inclinometers and gyroscopes, goniometers, pressure and or force sensors, and physical motion capture devices.

7. The arrangement as claimed in claim 1, wherein said motion capture device is the combination of a motion capture camera in conjunction with any one of accelerometers, inclinometers and gyroscopes, goniometers, pressure and or force sensors, and physical motion capture devices.

8. The arrangement as claimed in claim 1, wherein said control module is a computer.

9. The arrangement as claimed in claim 1, wherein said control module may store the results of a therapy session, including the controls for said gait device, such that said stored session may be used in a subsequent session, using similar control signals for said gait device, without the need for using said motion capture device.

10. The arrangement as claimed in claim 1, wherein said gait device is configured to assist the rehabilitation gait of an affected leg via three arms, one for the thigh, one for the calf and one for the ankle/foot.

11. The arrangement as claimed in claim 10, wherein said arms of said gait device move independently from one another.

12. The arrangement as claimed in claim 11, wherein said arms may each move independently in an X and Y axis of motion.

13. The arrangement as claimed in claim 12, wherein said gait device separately moves in total in the Z axis.

14. The arrangement as claimed in claim 10, wherein said gait device includes straps at each of said arms for securing said limb to said arms.

15. The arrangement as claimed in claim 14, wherein said straps include pressure sensors, coupled to said controller for sending signals related to said user's limb movements and level of assistance provided by said gait device.
